(19) United States
(12) Patent Application Publication
(10) Pub. No.: US 2021/0399482 A1
(43) Pub. Date: Dec. 23, 2021

(54) CARD CONNECTOR

(71) Applicant: V-GENERAL TECHNOLOGY CO., LTD., New Taipei City (TW)

(72) Inventors: PO-WEN YEH, New Taipei City (TW); HSUAN HO CHUNG, New Taipei City (TW); YUNG-CHANG LIN, New Taipei City (TW); YU HUNG LIN, New Taipei City (TW); TZU-WEI YEH, New Taipei City (TW); YU-LUN YEH, New Taipei City (TW)

(21) Appl. No.: 17/349,872

(22) Filed: Jun. 16, 2021

(30) Foreign Application Priority Data
Jun. 19, 2020 (TW) 109120803

(51) Int. Cl. H01R 13/6471; H01R 4/02; H01R 13/6585; H01R 13/514; H01R 13/15

(52) U.S. Cl. CPC H01R 13/6471; H01R 4/02; H01R 13/15; H01R 13/514; H01R 13/6585

(57) ABSTRACT

A card connector includes a transmission conductor assembly. The transmission conductor assembly includes a first signal transmission conductor, a first power transmission conductor, an inspection signal transmission conductor, a second signal transmission conductor, a command reset transmission conductor, a first grounding transmission conductor, a second power transmission conductor, a first differential transmission conductor, a second differential transmission conductor, a third signal transmission conductor, a second grounding transmission conductor, a third grounding transmission conductor, a third differential transmission conductor, a fourth differential transmission conductor, a fourth grounding transmission conductor, a fifth grounding transmission conductor, a fifth differential transmission conductor, a sixth differential transmission conductor, and an outside grounding transmission conductor, each of which has a spring section and a soldering section. The soldering sections, being so arranged, achieve advantages of bettering high frequency performance, reducing capacitive effect, and suppressing electromagnetic radiation interference.

### TECHNICAL FIELD OF THE INVENTION

The present invention relates to a card connector, and more particularly to a card connector featuring bettered high frequency performance, reduced capacitive effect, and suppressed electromagnetic radiation interference.

### DESCRIPTION OF THE PRIOR ART

Security Digital, commonly abbreviated as SD, refers to a memory card, which is widely used in portable devices, such as digital cameras, personal digital assistants (PDAs), and multimedia players. SD technology is based on the MultiMediaCard (MMC) format. The SD card has a relatively high data transmission rate and is constantly updating the standards thereof. Most of the SD cards are provided with, on a lateral side thereof, with write protection control to prevent accidental data writing in the card. Some of the SD cards even support digital copyright management technology. The size of the SD cards is generally 32 mm×24 mm×2.1 mm but would be different for different types, such as micro SD. A micro SD card is a miniaturized flash memory card. Such a kind of memory card is mainly used in mobile phones, and is advantageous in that the size is extremely small. With the increase of capacity, it has started for use in global positioning systems (GPSs), portable music players, and some flash memory devices. The size of the micro SD cards is 15 mm×11 mm×1 mm, which is about a quarter of the size of the SD cards, corresponding to the size of a finger nail, and it is also connected, by means of an adaptor, to an SD or memory stick receptacle. The SD card is also referred to as an internal storage card or a memory card in the Chinese-speaking areas.

Generally speaking, the SD card requires multiple contact points for connection, and consequently, an SD receptacle also includes multiple terminal sets, which are of the same number and corresponding to such contact points. Due to such a large number of terminals, mutual interference may be quite possibly induced between the terminals, and a capacitive effect may be generated.

### SUMMARY OF THE INVENTION

In view of the above drawbacks, the present invention is developed through repeated study and modification in order to provide a card connector that betters high frequency performance, reduces the capacitive effect, and suppresses electromagnetic radiation interference.

The primary objective of the present invention is to realize advantages of bettering high frequency performance, reducing the capacitive effect, and suppressing electromagnetic radiation interference by providing an arrangement of soldering sections, in which differential soldering sections are arranged side by side in a pairwise form and the differential soldering sections are separated by grounding sections arranged therebetween.

To achieve the above objective, the present invention comprises a transmission conductor assembly. A structure of the transmission conductor assembly mainly comprises: a first signal transmission conductor, a first power transmission conductor, an inspection signal transmission conductor, a second signal transmission conductor, a command reset transmission conductor, a first grounding transmission conductor, a second power transmission conductor, a first differential transmission conductor, a second differential transmission conductor, a third signal transmission conductor, a second grounding transmission conductor, a third grounding transmission conductor, a third differential transmission conductor, a fourth differential transmission conductor, a fourth grounding transmission conductor, a fifth grounding transmission conductor, a fifth differential transmission conductor, a sixth differential transmission conductor, and an outside grounding transmission conductor;

wherein the first signal transmission conductor has two ends that are extended to respectively form a first signal soldering section and a first signal spring section;

the first power transmission conductor has two ends that are extended to respectively form a first power soldering section and a first power spring section, and the first power soldering section is located at one side of the first signal soldering section;

the inspection signal transmission conductor has two ends that are extended to respectively form an inspection signal soldering section and an inspection signal spring section, and the inspection signal soldering section is located at one side of the first power soldering section that is distant from the first signal soldering section, and the inspection signal spring section is located at one side of the first signal spring section;

the second signal transmission conductor has two ends that are extended to respectively form a second signal soldering section and a second signal spring section, and the second signal soldering section is located at one side of the inspection signal soldering section that is distant from the first power soldering section, and the second signal spring section is located at one side of the first power spring section;

the command reset transmission conductor has two ends that are extended to respectively form a command reset soldering section and a command reset spring section, and the command reset soldering section is located at one side of the second signal soldering section that is distant from the inspection signal soldering section, and the command reset spring section is located at one side of the inspection signal spring section that is distant from the first signal spring section;

the first grounding transmission conductor has two ends that are extended to respectively form a first grounding soldering section and a first grounding spring section, and the first grounding soldering section is located at one side of the command reset soldering section that is distant from the second signal soldering section, and the first grounding spring section is located at one side of the second signal spring section that is distant from the first power spring section;

the second power transmission conductor has two ends that are extended to respectively form a second power soldering section and a second power spring section, and the second power soldering section is located at one side of the first grounding soldering section that is distant from the command reset soldering section, and the second power spring section is located at one side of the command reset spring section that is distant from the inspection signal spring section;

the first differential transmission conductor has two ends that are extended to respectively form a first differential soldering section and a first differential spring section, and the first differential soldering section is located at one side of the second power soldering section that is distant from the first grounding soldering section, and the first differential spring section is located at one side of the first grounding spring section that is distant from the second signal spring section;

the second differential transmission conductor has two ends that are extended to respectively form a second differential soldering section and a second differential spring section, and the second differential soldering section is located at one side of the first differential soldering section that is distant from the second power soldering section, and the second differential spring section is located at one side of the first differential spring section that is distant from the first grounding spring section;

the third signal transmission conductor has two ends that are extended to respectively form a third signal soldering section and a third signal spring section, and the third signal soldering section is located at one side of the second differential soldering section that is distant from the first differential soldering section, and the third signal spring section is located at one side of the second power spring section that is distant from the command reset spring section;

the second grounding transmission conductor has two ends that are extended to respectively form a second grounding soldering section and a second grounding spring section, and the second grounding soldering section is located at one side of the third signal soldering section that is distant from the second differential soldering section, and the second grounding spring section is located at one side of the second differential spring section that is distant from the first differential spring section;

the third grounding transmission conductor has two ends that are extended to respectively form a third grounding soldering section and a third grounding spring section, and the third grounding soldering section is located at one side of the second grounding soldering section that is distant from the third signal soldering section, and the third grounding spring section is located at one side of the third signal spring section that is distant from the second power spring section;

the third differential transmission conductor has two ends that are extended to respectively form a third differential soldering section and a third differential spring section, and the third differential soldering section is located at one side of the third grounding soldering section that is distant from the second grounding soldering section, and the third differential spring section is located at one side of the second grounding spring section that is distant from the second differential spring section;

the fourth differential transmission conductor has two ends that are extended to respectively form a fourth differential soldering section and a fourth differential spring section, and the fourth differential soldering section is located at one side of the third differential soldering section that is distant from the third grounding soldering section, and the fourth differential spring section is located at one side of the third differential spring section that is distant from the second grounding spring section;

the fourth grounding transmission conductor has two ends that are extended to respectively form a fourth grounding soldering section and a fourth grounding spring section, and the fourth grounding soldering section is located at one side of the fourth differential soldering section that is distant from the third differential soldering section, the fourth grounding spring section is located at one side of the third grounding spring section that is distant from the third signal spring section;

the fifth grounding transmission conductor has two ends that are extended to respectively form a fifth grounding soldering section and a fifth grounding spring section, and the fifth grounding soldering section is located at one side of the fourth grounding soldering section that is distant from the fourth differential soldering section, and the fifth grounding spring section is located at one side of the fourth differential spring section that is distant from the third differential spring section;

the fifth differential transmission conductor has two ends that are extended to respectively form a fifth differential soldering section and a fifth differential spring section, and the fifth differential soldering section is located at one side of the fifth grounding soldering section that is distant from the fourth grounding soldering section, and the fifth differential spring section is located at one side of the fourth grounding spring section that is distant from the third grounding spring section;

the sixth differential transmission conductor has two ends that are extended to respectively form a sixth differential soldering section and a sixth differential spring section, and the sixth differential soldering section is located at one side of the fifth differential soldering section that is distant from the fifth grounding soldering section, and the sixth differential spring section is located at one side of the fifth differential spring section that is distant from the fourth grounding spring section; and

the outside grounding transmission conductor has two ends that respectively form a first outside grounding soldering section and a second outside grounding soldering section, and the outside grounding transmission conductor is formed with a retaining engagement spring section located at one side of the first signal spring section, and the first outside grounding soldering section is located at one side of the first signal soldering section that is distant from the first power soldering section, and the second outside grounding soldering section is located at one side of the sixth differential soldering section that is distant from the fifth differential soldering section.

Based on the above structure, the first differential soldering section and the second differential soldering section, the third differential soldering section and the fourth differential soldering section, and the fifth differential soldering section and the sixth differential soldering section are arranged side by side in a pairwise form, and the second grounding soldering section is arranged between the first and second differential soldering sections and the third and fourth differential soldering sections; and the fourth grounding soldering section and the fifth grounding soldering section are arranged between the third and fourth differential soldering sections and the fifth and sixth differential soldering sections, so that capacitive effect can be reduced and thus bettering of the high frequency performance and suppressing of electromagnetic radiation interference can be realized.

### BRIEF DESCRIPTION OF THE DRAWINGS

FIG. 1 is a perspective view showing the present invention.

FIG. 2 is a schematic view showing a transmission conductor assembly of the present invention.

FIG. 3 is another schematic view showing the transmission conductor assembly of the present invention.

FIG. 4 is a schematic view showing an insulative plastic body of the present invention.

FIG. 5 is a schematic view demonstrating insertion according the present invention.

FIG. 6 is a schematic view demonstrating retaining engagement according to the present invention.

FIG. 7 is a schematic view demonstrating contacting according to the present invention.

### DETAILED DESCRIPTION OF THE PREFERRED EMBODIMENT

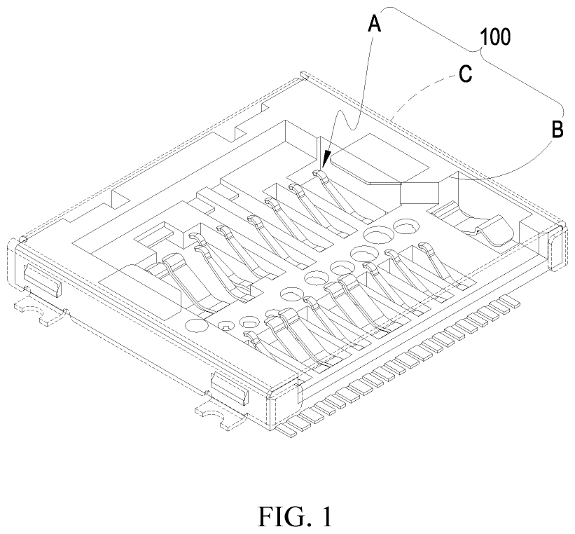

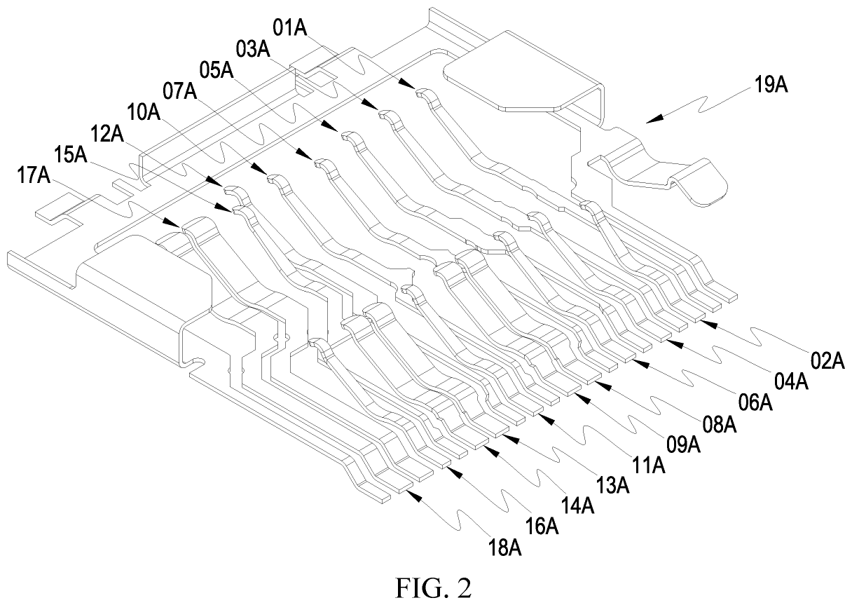

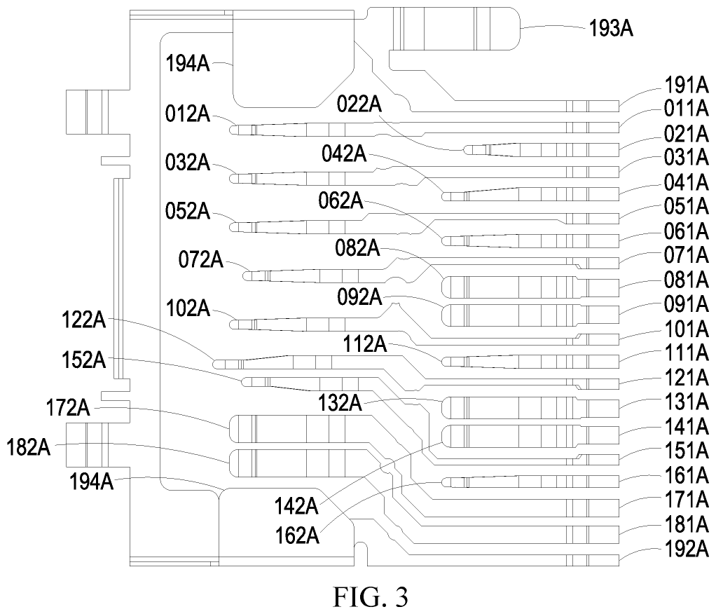

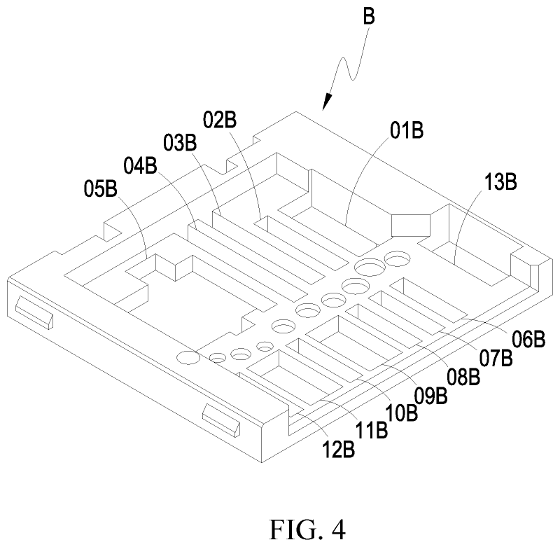

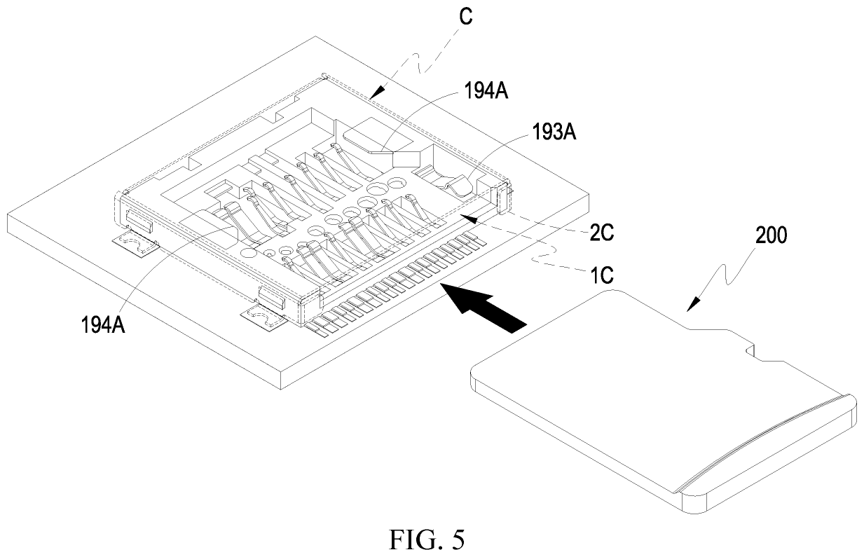

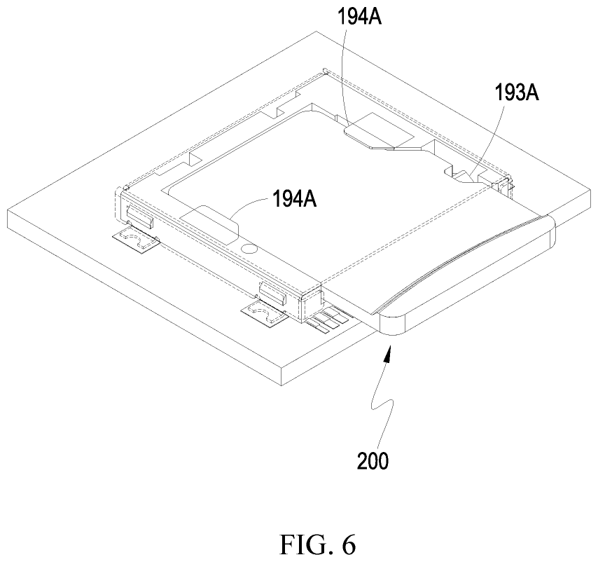

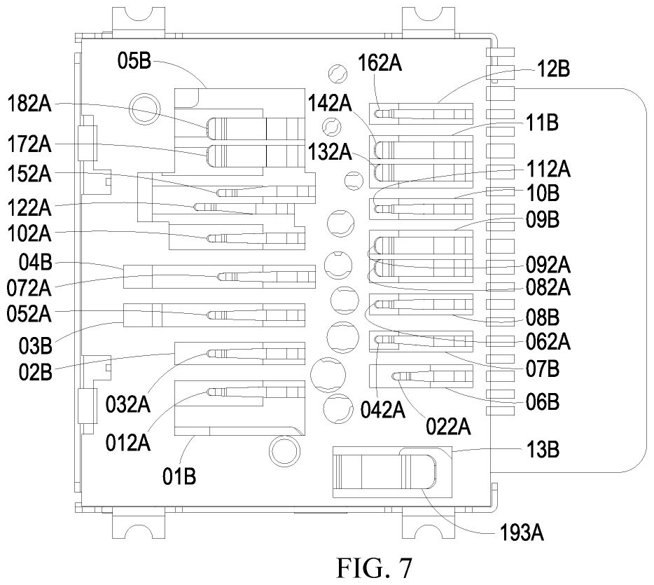

Referring to FIGS. 1-7, the drawings clearly show the present invention provides a card connector 100. The card connector 100 comprises a transmission conductor assembly A, an insulative plastic body B arranged outside the transmission conductor assembly A, and a shielding case C arranged outside the insulative plastic body B. The transmission conductor assembly A is arranged to meet the specification of microSD. The transmission conductor assembly A comprises:

a first signal transmission conductor 01A, wherein the first signal transmission conductor 01A has two ends that are extended to respectively form a first signal soldering section 011A and a first signal spring section 012A;

a first power transmission conductor 02A, wherein the first power transmission conductor 02A has two ends that are extended to respectively form a first power soldering section 021A and a first power spring section 022A, and the first power soldering section 021A is located at one side of the first signal soldering section 011A;

an inspection signal transmission conductor 03A, wherein the inspection signal transmission conductor 03A has two ends that are extended to respectively form an inspection signal soldering section 031A and an inspection signal spring section 032A, and the inspection signal soldering section 031A is located at one side of the first power soldering section 021A that is distant from the first signal soldering section 011A, and the inspection signal spring section 032A is located at one side of the first signal spring section 012A;

a second signal transmission conductor 04A, wherein the second signal transmission conductor 04A has two ends that are extended to respectively form a second signal soldering section 041A and a second signal spring section 042A, and the second signal soldering section 041A is located at one side of the inspection signal soldering section 031A that is distant from the first power soldering section 021A, and the second signal spring section 042A is located at one side of the first power spring section 022A;

a command reset transmission conductor 05A, wherein the command reset transmission conductor 05A has two ends that are extended to respectively form a command reset soldering section 051A and a command reset spring section 052A, and the command reset soldering section 051A is located at one side of the second signal soldering section 041A that is distant from the inspection signal soldering section 031A, and the command reset spring section 052A is located at one side of the inspection signal spring section 032A that is distant from the first signal spring section 012A;

a first grounding transmission conductor 06A, wherein the first grounding transmission conductor 06A has two ends that are extended to respectively form a first grounding soldering section 061A and a first grounding spring section 062A, and the first grounding soldering section 061A is located at one side of the command reset soldering section 051A that is distant from the second signal soldering section 041A, and the first grounding spring section 062A is located at one side of the second signal spring section 042A that is distant from the first power spring section 022A;

a second power transmission conductor 07A, wherein the second power transmission conductor 07A has two ends that are extended to respectively form a second power soldering section 071A and a second power spring section 072A, and the second power soldering section 071A is located at one side of the first grounding soldering section 061A that is distant from the command reset soldering section 051A, and the second power spring section 072A is located at one side of the command reset spring section 052A that is distant from the inspection signal spring section 032A;

a first differential transmission conductor 08A, wherein the first differential transmission conductor 08A has two ends that are extended to respectively form a first differential soldering section 081A and a first differential spring section 082A, and the first differential soldering section 081A is located at one side of the second power soldering section 071A that is distant from the first grounding soldering section 061A, and the first differential spring section 082A is located at one side of the first grounding spring section 062A that is distant from the second signal spring section 042A;

a second differential transmission conductor 09A, wherein the second differential transmission conductor 09A has two ends that are extended to respectively form a second differential soldering section 091A and a second differential spring section 092A, and the second differential soldering section 091A is located at one side of the first differential soldering section 081A that is distant from the second power soldering section 071A, and the second differential spring section 092A is located at one side of the first differential spring section 082A that is distant from the first grounding spring section 062A;

a third signal transmission conductor 10A, wherein the third signal transmission conductor 10A has two ends that are extended to respectively form a third signal soldering section 101A and a third signal spring section 102A, and the third signal soldering section 101A is located at one side of the second differential soldering section 091A that is distant from the first differential soldering section 081A, and the third signal spring section 102A is located at one side of the second power spring section 072A that is distant from the command reset spring section 052A;

a second grounding transmission conductor 11A, wherein the second grounding transmission conductor 11A has two ends that are extended to respectively form a second grounding soldering section 111A and a second grounding spring section 112A, and the second grounding soldering section 111A is located at one side of the third signal soldering section 101A that is distant from the second differential soldering section 091A, and the second grounding spring section 112A is located at one side of the second differential spring section 092A that is distant from the first differential spring section 082A;

a third grounding transmission conductor 12A, wherein the third grounding transmission conductor 12A has two ends that are extended to respectively form a third grounding soldering section 121A and a third grounding spring section 122A, and the third grounding soldering section 121A is located at one side of the second grounding soldering section 111A that is distant from the third signal soldering section 101A, and the third grounding spring section 122A is located at one side of the third signal spring section 102A that is distant from the second power spring section 072A;

a third differential transmission conductor 13A, wherein the third differential transmission conductor 13A has two ends that are extended to respectively form a third differential soldering section 131A and a third differential spring section 132A, and the third differential soldering section 131A is located at one side of the third grounding soldering section 121A that is distant from the second grounding soldering section 111A, and the third differential spring section 132A is located at one side of the second grounding spring section 112A that is distant from the second differential spring section 092A;

a fourth differential transmission conductor 14A, wherein the fourth differential transmission conductor 14A has two ends that are extended to respectively form a fourth differential soldering section 141A and a fourth differential spring section 142A, and the fourth differential soldering section 141A is located at one side of the third differential soldering section 131A that is distant from the third grounding soldering section 121A, and the fourth differential spring section 142A is located at one side of the third differential spring section 132A that is distant from the second grounding spring section 112A;

a fourth grounding transmission conductor 15A, wherein the fourth grounding transmission conductor 15A has two ends that are extended to respectively form a fourth grounding soldering section 151A and a fourth grounding spring section 152A, and the fourth grounding soldering section 151A is located at one side of the fourth differential soldering section 141A that is distant from the third differential soldering section 131A, the fourth grounding spring section 152A is located at one side of the third grounding spring section 122A that is distant from the third signal spring section 102A;

a fifth grounding transmission conductor 16A, wherein the fifth grounding transmission conductor 16A has two ends that are extended to respectively form a fifth grounding soldering section 161A and a fifth grounding spring section 162A, and the fifth grounding soldering section 161A is located at one side of the fourth grounding soldering section 151A that is distant from the fourth differential soldering section 141A, and the fifth grounding spring section 162A is located at one side of the fourth differential spring section 142A that is distant from the third differential spring section 132A;

a fifth differential transmission conductor 17A, wherein the fifth differential transmission conductor 17A has two ends that are extended to respectively form a fifth differential soldering section 171A and a fifth differential spring section 172A, and the fifth differential soldering section 171A is located at one side of the fifth grounding soldering section 161A that is distant from the fourth grounding soldering section 151A, and the fifth differential spring section 172A is located at one side of the fourth grounding spring section 152A that is distant from the third grounding spring section 122A;

a sixth differential transmission conductor 18A, wherein the sixth differential transmission conductor 18A has two ends that are extended to respectively form a sixth differential soldering section 181A and a sixth differential spring section 182A, and the sixth differential soldering section 181A is located at one side of the fifth differential soldering section 171A that is distant from the fifth grounding soldering section 161A, and the sixth differential spring section 182A is located at one side of the fifth differential spring section 172A that is distant from the fourth grounding spring section 152A; and

an outside grounding transmission conductor 19A, wherein the outside grounding transmission conductor 19A has two ends that respectively form a first outside grounding soldering section 191A and a second outside grounding soldering section 192A, and the outside grounding transmission conductor 19A is formed with a retaining engagement spring section 193A located at one side of the first signal spring section 012A, and the first outside grounding soldering section 191A is located at one side of the first signal soldering section 011A that is distant from the first power soldering section 021A, and the second outside grounding soldering section 192A is located at one side of the sixth differential soldering section 181A that is distant from the fifth differential soldering section 171A.

Further, the first differential transmission conductor 08A, the second differential transmission conductor 09A, the third differential transmission conductor 13A, the fourth differential transmission conductor 14A, the fifth differential transmission conductor 17A, and the sixth differential transmission conductor 18A have widths that are greater than widths of the first signal transmission conductor 01A, the inspection signal transmission conductor 03A, the command reset transmission conductor 05A, the second power transmission conductor 07A, the third signal transmission conductor 10A, the third grounding transmission conductor 12A, the fourth grounding transmission conductor 15A, the first power transmission conductor 02A, the second signal transmission conductor 04A, the first grounding transmission conductor 06A, the second grounding transmission conductor 11A, the fifth grounding transmission conductor 16A, in order to achieve an effect of enhancing high frequency performance.

Further, the insulative plastic body B is provided with a first signal constraining section 01B, an inspection signal constraining section 02B located at one side of the first signal constraining section 01B, a command reset constraining section 03B located at one side of the inspection signal constraining section 02B that is distant from the first signal constraining section 01B, a second power constraining section 04B located at one side of the command reset constraining section 03B that is distant from the inspection signal constraining section 02B, a first differential group constraining section 05B located at one side of the second power constraining section 04B that is distant from the command reset constraining section 03B, a first power constraining section 06B located at one side of the first signal constraining section 01B, a second signal constraining section 07B located at one side of the first power constraining section 06B, a first grounding constraining section 08B located at one side of the second signal constraining section 07B that is distant from the first power constraining section 06B, a second differential group constraining section 09B located at one side of the first grounding constraining section 08B that is distant from the second signal constraining section 07B, a second grounding constraining section 10B located at one side of the second differential group constraining section 09B that is distant from the first grounding constraining section 08B, a third differential group constraining section 11B located at one side of the second grounding constraining section 10B that is distant from the second differential group constraining section 09B, a fifth grounding constraining section 12B located at one side of the third differential group constraining section 11B that is distant from the second grounding constraining section 10B, and a retaining engagement spring constraining section 13B located at one side of the first power constraining section 06B.

Further, the outside grounding transmission conductor 19A of the transmission conductor assembly A is formed with a plurality of constraint fixing sections 194A, and the shielding case C is provided with a plurality of collision protection sections 2C beside an opening 1C thereof.

The above description provides an understanding to the structure of the present invention, and based on a combination of such a structure, advantages of bettered high frequency performance, reduced capacitive effect, and suppressed electromagnetic radiation interference may be realized. Details for explanation are provided below.

A users may insert an SC card 200 through the opening 1C into the shielding case C, and the shielding case C may reinforce an overall structural strength by means of the collision protection sections 2C. The SC card 200, upon insertion into the shielding case C, may attain an effect of constraining and fixing by means of the retaining engagement spring section 193A and the constraint fixing sections 194A. The SC card 200 is brought into contact engagement with the transmission conductor assembly A, and for the transmission conductor assembly A, the first signal spring section 012A is received into and constrained in the first signal constraining section 01B; the inspection signal spring section 032A is received into and constrained in the inspection signal constraining section 02B; the command reset spring section 052A is received into and constrained in the command reset constraining section 03B; the second power spring section 072A is received into and constrained in the second power constraining section 04B; the third signal spring section 102A, the third grounding spring section 122A, the fourth grounding spring section 152A, the fifth differential spring section 172A, and the sixth differential spring section 182A are received into and constrained in the first differential group constraining section 05B; the first power spring section 022A is received into and constrained in the first power constraining section 06B; the second signal spring section 042A is received into and constrained in the second signal constraining section 07B; the first grounding spring section 062A is received into and constrained in the first grounding constraining section 08B; the first differential spring section 082A and the second differential spring section 092A are received into and constrained in the second differential group constraining section 09B; the second grounding spring section 112A is received into and constrained in the second grounding constraining section 10B; the third differential spring section 132A and the fourth differential spring section 142A are received into and constrained in the third differential group constraining section 11B; the fifth grounding spring section 162A is received into and constrained in the fifth grounding constraining section 12B; and the retaining engagement spring section 193A is received into and constrained in the retaining engagement spring constraining section 13B.

Further, contact points of the SC card 200 are set in contact engagement with the first signal spring section 012A, the first power spring section 022A, the inspection signal spring section 032A, the second signal spring section 042A, the command reset spring section 052A, the first grounding spring section 062A, the second power spring section 072A, the first differential spring section 082A, the second differential spring section 092A, the third signal spring section 102A, the second grounding spring section 112A, the third grounding spring section 122A, the third differential spring section 132A, the fourth differential spring section 142A, the fourth grounding spring section 152A, the fifth grounding spring section 162A, the fifth differential spring section 172A, and the sixth differential spring section 182A of the transmission conductor assembly A, in order to establish connection between the SC card 200 and the transmission conductor assembly A, and also to set the retaining engagement spring section 193A in retaining engagement with one side of the SC card 200 to assist fixing the SC card 200. During transmission of signals, due to the first differential soldering section 081A and the second differential soldering section 091A, the third differential soldering section 131A and the fourth differential soldering section 141A, and the fifth differential soldering section 171A and the sixth differential soldering section 181A being respectively arranged side by side in a pairwise form, and the first differential soldering section 081A and the second differential soldering section 091A being provided, on two opposite sides thereof, with the first grounding soldering section 061A and the second grounding soldering section 111A, and the third differential soldering section 131A and the fourth differential soldering section 141A being provided, on two opposite sides thereof, with the third grounding soldering section 121A and the fourth grounding soldering section 151A, and the fifth differential soldering section 171A and the sixth differential soldering section 181A being provided, on two opposite sides thereof, with the fifth grounding soldering section 161A and the second outside grounding soldering section 192A, each differential group is provided, on two opposite sides thereof, with grounding sections, such that, by means of the above-described arrangement, advantages of bettering high frequency performance, reducing capacitive effect, and suppressing electromagnetic radiation interference can be realized.

I claim:

1. A card connector, the card connector comprising a transmission conductor assembly, wherein the transmission conductor assembly mainly comprises:
a first signal transmission conductor, wherein the first signal transmission conductor has an end extended to form a first signal soldering section;
a first power transmission conductor, wherein the first power transmission conductor has an end extended to form a first power soldering section, and the first power soldering section is located at one side of the first signal soldering section;
an inspection signal transmission conductor, wherein the inspection signal transmission conductor has an end extended to form an inspection signal soldering section, and the inspection signal soldering section is located at one side of the first power soldering section that is distant from the first signal soldering section;
a second signal transmission conductor, wherein the second signal transmission conductor has an end extended to form a second signal soldering section, and the second signal soldering section is located at one side of the inspection signal soldering section that is distant from the first power soldering section;
a command reset transmission conductor, wherein the command reset transmission conductor has an end extended to form a command reset soldering section, and the command reset soldering section is located at one side of the second signal soldering section that is distant from the inspection signal soldering section;
a first grounding transmission conductor, wherein the first grounding transmission conductor has an end extended to form a first grounding soldering section, and the first grounding soldering section is located at one side of the command reset soldering section that is distant from the second signal soldering section;
a second power transmission conductor, wherein the second power transmission conductor has an end extended to form a second power soldering section, and the second power soldering section is located at one side of the first grounding soldering section that is distant from the command reset soldering section;
a first differential transmission conductor, wherein the first differential transmission conductor has an end extended to form a first differential soldering section, and the first differential soldering section is located at one side of the second power soldering section that is distant from the first grounding soldering section;
a second differential transmission conductor, wherein the second differential transmission conductor has an end extended to form a second differential soldering section, and the second differential soldering section is located at one side of the first differential soldering section that is distant from the second power soldering section;
a third signal transmission conductor, wherein the third signal transmission conductor has an end extended to form a third signal soldering section, and the third signal soldering section is located at one side of the second differential soldering section that is distant from the first differential soldering section;
a second grounding transmission conductor, wherein the second grounding transmission conductor has an end extended to form a second grounding soldering section, and the second grounding soldering section is located at one side of the third signal soldering section that is distant from the second differential soldering section;
a third grounding transmission conductor, wherein the third grounding transmission conductor has an end extended to form a third grounding soldering section, and the third grounding soldering section is located at one side of the second grounding soldering section that is distant from the third signal soldering section;
a third differential transmission conductor, wherein the third differential transmission conductor has an end extended to form a third differential soldering section, and the third differential soldering section is located at one side of the third grounding soldering section that is distant from the second grounding soldering section;
a fourth differential transmission conductor, wherein the fourth differential transmission conductor has an end extended to form a fourth differential soldering section, and the fourth differential soldering section is located at one side of the third differential soldering section that is distant from the third grounding soldering section;
a fourth grounding transmission conductor, wherein the fourth grounding transmission conductor has an end extended to form a fourth grounding soldering section, and the fourth grounding soldering section is located at one side of the fourth differential soldering section that is distant from the third differential soldering section;
a fifth grounding transmission conductor, wherein the fifth grounding transmission conductor has an end extended to form a fifth grounding soldering section, and the fifth grounding soldering section is located at one side of the fourth grounding soldering section that is distant from the fourth differential soldering section;
a fifth differential transmission conductor, wherein the fifth differential transmission conductor has an end extended to form a fifth differential soldering section, and the fifth differential soldering section is located at one side of the fifth grounding soldering section that is distant from the fourth grounding soldering section; and
a sixth differential transmission conductor, wherein the sixth differential transmission conductor has an end extended to form a sixth differential soldering section, and the sixth differential soldering section is located at one side of the fifth differential soldering section that is distant from the fifth grounding soldering section.

2. The card connector according to claim 1, wherein an insulative plastic body is arranged outside the transmission conductor assembly, and the insulative plastic body is provided with a first signal constraining section, an inspection signal constraining section located at one side of the first signal constraining section, a command reset constraining section located at one side of the inspection signal constraining section that is distant from the first signal constraining section, a second power constraining section located at one side of the command reset constraining section that is distant from the inspection signal constraining section, a first differential group constraining section located at one side of the second power constraining section that is distant from the command reset constraining section, a first power constraining section located at one side of the first signal constraining section, a second signal constraining section located at one side of the first power constraining section, a first grounding constraining section located at one side of the second signal constraining section that is distant from the first power constraining section, a second differential group constraining section located at one side of the first grounding constraining section that is distant from the second signal constraining section, a second grounding constraining section located at one side of the second differential group constraining section that is distant from the first grounding constraining section, a third differential group constraining section located at one side of the second grounding constraining section that is distant from the second differential group constraining section, and a fifth grounding constraining section located at one side of the third differential group constraining section that is distant from the second grounding constraining section.

3. The card connector according to claim 1, wherein the transmission conductor assembly is formed with a plurality of constraint fixing sections.

4. The card connector according to claim 1, wherein a shielding case is arranged outside the transmission conductor assembly, and the shielding case is provided with a plurality of collision protection sections.

5. The card connector according to claim 1, wherein the fifth differential transmission conductor, the sixth differential transmission conductor, the first differential transmission conductor, the second differential transmission conductor, the third differential transmission conductor, and the fourth differential transmission conductor have widths that are greater than widths of the first signal transmission conductor, the inspection signal transmission conductor, the command reset transmission conductor, the second power transmission conductor, the third signal transmission conductor, the third grounding transmission conductor, the fourth grounding transmission conductor, the first power transmission conductor, the second signal transmission conductor, the first grounding transmission conductor, the second grounding transmission conductor, and the fifth grounding transmission conductor.

6. A card connector, the card connector comprising a transmission conductor assembly, wherein the transmission conductor assembly mainly comprises:
a first signal transmission conductor, wherein the first signal transmission conductor has two ends that are extended to respectively form a first signal soldering section and a first signal spring section;
a first power transmission conductor, wherein the first power transmission conductor has two ends that are extended to respectively form a first power soldering section and a first power spring section, and the first power soldering section is located at one side of the first signal soldering section;
an inspection signal transmission conductor, wherein the inspection signal transmission conductor has two ends that are extended to respectively form an inspection signal soldering section and an inspection signal spring section, and the inspection signal soldering section is located at one side of the first power soldering section that is distant from the first signal soldering section, and the inspection signal spring section is located at one side of the first signal spring section;
a second signal transmission conductor, wherein the second signal transmission conductor has two ends that are extended to respectively form a second signal soldering section and a second signal spring section, and the second signal soldering section is located at one side of the inspection signal soldering section that is distant from the first power soldering section, and the second signal spring section is located at one side of the first power spring section;
a command reset transmission conductor, wherein the command reset transmission conductor has two ends that are extended to respectively form a command reset soldering section and a command reset spring section, and the command reset soldering section is located at one side of the second signal soldering section that is distant from the inspection signal soldering section, and the command reset spring section is located at one side of the inspection signal spring section that is distant from the first signal spring section;
a first grounding transmission conductor, wherein the first grounding transmission conductor has two ends that are extended to respectively form a first grounding soldering section and a first grounding spring section, and the first grounding soldering section is located at one side of the command reset soldering section that is distant from the second signal soldering section, and the first grounding spring section is located at one side of the second signal spring section that is distant from the first power spring section;
a second power transmission conductor, wherein the second power transmission conductor has two ends that are extended to respectively form a second power soldering section and a second power spring section, and the second power soldering section is located at one side of the first grounding soldering section that is distant from the command reset soldering section, and the second power spring section is located at one side of the command reset spring section that is distant from the inspection signal spring section;
a first differential transmission conductor, wherein the first differential transmission conductor has two ends that are extended to respectively form a first differential soldering section and a first differential spring section, and the first differential soldering section is located at one side of the second power soldering section that is distant from the first grounding soldering section, and the first differential spring section is located at one side of the first grounding spring section that is distant from the second signal spring section;
a second differential transmission conductor, wherein the second differential transmission conductor has two ends that are extended to respectively form a second differential soldering section and a second differential spring section, and the second differential soldering section is located at one side of the first differential soldering section that is distant from the second power soldering section, and the second differential spring section is located at one side of the first differential spring section that is distant from the first grounding spring section;
a third signal transmission conductor, wherein the third signal transmission conductor has two ends that are extended to respectively form a third signal soldering section and a third signal spring section, and the third signal soldering section is located at one side of the second differential soldering section that is distant from the first differential soldering section, and the third signal spring section is located at one side of the second power spring section that is distant from the command reset spring section;
a second grounding transmission conductor, wherein the second grounding transmission conductor has two ends that are extended to respectively form a second grounding soldering section and a second grounding spring section, and the second grounding soldering section is located at one side of the third signal soldering section that is distant from the second differential soldering section, and the second grounding spring section is located at one side of the second differential spring section that is distant from the first differential spring section;
a third grounding transmission conductor, wherein the third grounding transmission conductor has two ends that are extended to respectively form a third grounding soldering section and a third grounding spring section, and the third grounding soldering section is located at one side of the second grounding soldering section that is distant from the third signal soldering section, and the third grounding spring section is located at one side of the third signal spring section that is distant from the second power spring section;
a third differential transmission conductor, wherein the third differential transmission conductor has two ends that are extended to respectively form a third differential soldering section and a third differential spring section, and the third differential soldering section is located at one side of the third grounding soldering section that is distant from the second grounding soldering section, and the third differential spring section is located at one side of the second grounding spring section that is distant from the second differential spring section;
a fourth differential transmission conductor, wherein the fourth differential transmission conductor has two ends that are extended to respectively form a fourth differential soldering section and a fourth differential spring section, and the fourth differential soldering section is located at one side of the third differential soldering section that is distant from the third grounding soldering section, and the fourth differential spring section is located at one side of the third differential spring section that is distant from the second grounding spring section;
a fourth grounding transmission conductor, wherein the fourth grounding transmission conductor has two ends that are extended to respectively form a fourth grounding soldering section and a fourth grounding spring section, and the fourth grounding soldering section is located at one side of the fourth differential soldering section that is distant from the third differential soldering section, the fourth grounding spring section is located at one side of the third grounding spring section that is distant from the third signal spring section;
a fifth grounding transmission conductor, wherein the fifth grounding transmission conductor has two ends that are extended to respectively form a fifth grounding soldering section and a fifth grounding spring section, and the fifth grounding soldering section is located at one side of the fourth grounding soldering section that is distant from the fourth differential soldering section, and the fifth grounding spring section is located at one side of the fourth differential spring section that is distant from the third differential spring section;
a fifth differential transmission conductor, wherein the fifth differential transmission conductor has two ends that are extended to respectively form a fifth differential soldering section and a fifth differential spring section, and the fifth differential soldering section is located at one side of the fifth grounding soldering section that is distant from the fourth grounding soldering section, and the fifth differential spring section is located at one side of the fourth grounding spring section that is distant from the third grounding spring section; and
a sixth differential transmission conductor, wherein the sixth differential transmission conductor has two ends that are extended to respectively form a sixth differential soldering section and a sixth differential spring section, and the sixth differential soldering section is located at one side of the fifth differential soldering section that is distant from the fifth grounding soldering section, and the sixth differential spring section is located at one side of the fifth differential spring section that is distant from the fourth grounding spring section.

7. The card connector according to claim 6, wherein an insulative plastic body is arranged outside the transmission conductor assembly, and the insulative plastic body is provided with a first signal constraining section, an inspection signal constraining section located at one side of the first signal constraining section, a command reset constraining section located at one side of the inspection signal constraining section that is distant from the first signal constraining section, a second power constraining section located at one side of the command reset constraining section that is distant from the inspection signal constraining section, a first differential group constraining section located at one side of the second power constraining section that is distant from the command reset constraining section, a first power constraining section located at one side of the first signal constraining section, a second signal constraining section located at one side of the first power constraining section, a first grounding constraining section located at one side of the second signal constraining section that is distant from the first power constraining section, a second differential group constraining section located at one side of the first grounding constraining section that is distant from the second signal constraining section, a second grounding constraining section located at one side of the second differential group constraining section that is distant from the first grounding constraining section, a third differential group constraining section located at one side of the second grounding constraining section that is distant from the second differential group constraining section, and a fifth grounding constraining section located at one side of the third differential group constraining section that is distant from the second grounding constraining section.

8. The card connector according to claim 6, wherein the transmission conductor assembly is formed with a plurality of constraint fixing sections.

9. The card connector according to claim 6, wherein a shielding case is arranged outside the transmission conductor assembly, and the shielding case is provided with a plurality of collision protection sections.

10. The card connector according to claim 6, wherein the fifth differential transmission conductor, the sixth differential transmission conductor, the first differential transmission conductor, the second differential transmission conductor, the third differential transmission conductor, and the fourth differential transmission conductor have widths that are greater than widths of the first signal transmission conductor, the inspection signal transmission conductor, the command reset transmission conductor, the second power transmission conductor, the third signal transmission conductor, the third grounding transmission conductor, the fourth grounding transmission conductor, the first power transmission conductor, the second signal transmission conductor, the first grounding transmission conductor, the second grounding transmission conductor, and the fifth grounding transmission conductor.

11. A card connector, the card connector comprising a transmission conductor assembly, wherein the transmission conductor assembly mainly comprises:
a first signal transmission conductor, wherein the first signal transmission conductor has an end extended to form a first signal soldering section;
a first power transmission conductor, wherein the first power transmission conductor has an end extended to form a first power soldering section, and the first power soldering section is located at one side of the first signal soldering section;
an inspection signal transmission conductor, wherein the inspection signal transmission conductor has an end extended to form an inspection signal soldering section, and the inspection signal soldering section is located at one side of the first power soldering section that is distant from the first signal soldering section;
a second signal transmission conductor, wherein the second signal transmission conductor has an end extended to form a second signal soldering section, and the second signal soldering section is located at one side of the inspection signal soldering section that is distant from the first power soldering section;
a command reset transmission conductor, wherein the command reset transmission conductor has an end extended to form a command reset soldering section, and the command reset soldering section is located at one side of the second signal soldering section that is distant from the inspection signal soldering section;
a first grounding transmission conductor, wherein the first grounding transmission conductor has an end extended to form a first grounding soldering section, and the first grounding soldering section is located at one side of the command reset soldering section that is distant from the second signal soldering section;
a second power transmission conductor, wherein the second power transmission conductor has an end extended to form a second power soldering section, and the second power soldering section is located at one side of the first grounding soldering section that is distant from the command reset soldering section;
a first differential transmission conductor, wherein the first differential transmission conductor has an end extended to form a first differential soldering section, and the first differential soldering section is located at one side of the second power soldering section that is distant from the first grounding soldering section;
a second differential transmission conductor, wherein the second differential transmission conductor has an end extended to form a second differential soldering section, and the second differential soldering section is located at one side of the first differential soldering section that is distant from the second power soldering section;
a third signal transmission conductor, wherein the third signal transmission conductor has an end extended to form a third signal soldering section, and the third signal soldering section is located at one side of the second differential soldering section that is distant from the first differential soldering section;
a second grounding transmission conductor, wherein the second grounding transmission conductor has an end extended to form a second grounding soldering section, and the second grounding soldering section is located at one side of the third signal soldering section that is distant from the second differential soldering section;
a third grounding transmission conductor, wherein the third grounding transmission conductor has an end extended to form a third grounding soldering section, and the third grounding soldering section is located at one side of the second grounding soldering section that is distant from the third signal soldering section;
a third differential transmission conductor, wherein the third differential transmission conductor has an end extended to form a third differential soldering section, and the third differential soldering section is located at one side of the third grounding soldering section that is distant from the second grounding soldering section;
a fourth differential transmission conductor, wherein the fourth differential transmission conductor has an end extended to form a fourth differential soldering section, and the fourth differential soldering section is located at one side of the third differential soldering section that is distant from the third grounding soldering section;
a fourth grounding transmission conductor, wherein the fourth grounding transmission conductor has an end extended to form a fourth grounding soldering section, and the fourth grounding soldering section is located at one side of the fourth differential soldering section that is distant from the third differential soldering section;
a fifth grounding transmission conductor, wherein the fifth grounding transmission conductor has an end extended to form a fifth grounding soldering section, and the fifth grounding soldering section is located at one side of the fourth grounding soldering section that is distant from the fourth differential soldering section;
a fifth differential transmission conductor, wherein the fifth differential transmission conductor has an end extended to form a fifth differential soldering section, and the fifth differential soldering section is located at one side of the fifth grounding soldering section that is distant from the fourth grounding soldering section;
a sixth differential transmission conductor, wherein the sixth differential transmission conductor has an end extended to form a sixth differential soldering section, and the sixth differential soldering section is located at one side of the fifth differential soldering section that is distant from the fifth grounding soldering section; and
an outside grounding transmission conductor, wherein the outside grounding transmission conductor has two ends that respectively form a first outside grounding soldering section and a second outside grounding soldering section, and the first outside grounding soldering section is located at one side of the first signal soldering section that is distant from the first power soldering section, and the second outside grounding soldering section is located at one side of the sixth differential soldering section that is distant from the fifth differential soldering section.

12. The card connector according to claim 11, wherein an insulative plastic body is arranged outside the transmission conductor assembly, and the insulative plastic body is provided with a first signal constraining section, an inspection signal constraining section located at one side of the first signal constraining section, a command reset constraining section located at one side of the inspection signal constraining section that is distant from the first signal constraining section, a second power constraining section located at one side of the command reset constraining section that is distant from the inspection signal constraining section, a first differential group constraining section located at one side of the second power constraining section that is distant from the command reset constraining section, a first power constraining section located at one side of the first signal constraining section, a second signal constraining section located at one side of the first power constraining section, a first grounding constraining section located at one side of the second signal constraining section that is distant from the first power constraining section, a second differential group constraining section located at one side of the first grounding constraining section that is distant from the second signal constraining section, a second grounding constraining section located at one side of the second differential group constraining section that is distant from the first grounding constraining section, a third differential group constraining section located at one side of the second grounding constraining section that is distant from the second differential group constraining section, a fifth grounding constraining section located at one side of the third differential group constraining section that is distant from the second grounding constraining section, and a retaining engagement spring constraining section located at one side of the first power constraining section.

13. The card connector according to claim 11, wherein the transmission conductor assembly is formed with a plurality of constraint fixing sections.

14. The card connector according to claim 11, wherein a shielding case is arranged outside the transmission conductor assembly, and the shielding case is provided with a plurality of collision protection sections.

15. The card connector according to claim 11, wherein the fifth differential transmission conductor, the sixth differential transmission conductor, the first differential transmission conductor, the second differential transmission conductor, the third differential transmission conductor, and the fourth differential transmission conductor have widths that are greater than widths of the first signal transmission conductor, the inspection signal transmission conductor, the command reset transmission conductor, the second power transmission conductor, the third signal transmission conductor, the third grounding transmission conductor, the fourth grounding transmission conductor, the first power transmission conductor, the second signal transmission conductor, the first grounding transmission conductor, the second grounding transmission conductor, and the fifth grounding transmission conductor.

16. A card connector, the card connector comprising a transmission conductor assembly, wherein the transmission conductor assembly mainly comprises:
a first signal transmission conductor, wherein the first signal transmission conductor has two ends that are extended to respectively form a first signal soldering section and a first signal spring section;
a first power transmission conductor, wherein the first power transmission conductor has two ends that are extended to respectively form a first power soldering section and a first power spring section, and the first power soldering section is located at one side of the first signal soldering section;
an inspection signal transmission conductor, wherein the inspection signal transmission conductor has two ends that are extended to respectively form an inspection signal soldering section and an inspection signal spring section, and the inspection signal soldering section is located at one side of the first power soldering section that is distant from the first signal soldering section, and the inspection signal spring section is located at one side of the first signal spring section;
a second signal transmission conductor, wherein the second signal transmission conductor has two ends that are extended to respectively form a second signal soldering section and a second signal spring section, and the second signal soldering section is located at one side of the inspection signal soldering section that is distant from the first power soldering section, and the second signal spring section is located at one side of the first power spring section;
a command reset transmission conductor, wherein the command reset transmission conductor has two ends that are extended to respectively form a command reset soldering section and a command reset spring section, and the command reset soldering section is located at one side of the second signal soldering section that is distant from the inspection signal soldering section, and the command reset spring section is located at one side of the inspection signal spring section that is distant from the first signal spring section;
a first grounding transmission conductor, wherein the first grounding transmission conductor has two ends that are extended to respectively form a first grounding soldering section and a first grounding spring section, and the first grounding soldering section is located at one side of the command reset soldering section that is distant from the second signal soldering section, and the first grounding spring section is located at one side of the second signal spring section that is distant from the first power spring section;
a second power transmission conductor, wherein the second power transmission conductor has two ends that are extended to respectively form a second power soldering section and a second power spring section, and the second power soldering section is located at one side of the first grounding soldering section that is distant from the command reset soldering section, and the second power spring section is located at one side of the command reset spring section that is distant from the inspection signal spring section;
a first differential transmission conductor, wherein the first differential transmission conductor has two ends that are extended to respectively form a first differential soldering section and a first differential spring section, and the first differential soldering section is located at one side of the second power soldering section that is distant from the first grounding soldering section, and the first differential spring section is located at one side of the first grounding spring section that is distant from the second signal spring section;
a second differential transmission conductor, wherein the second differential transmission conductor has two ends that are extended to respectively form a second differential soldering section and a second differential spring section, and the second differential soldering section is located at one side of the first differential soldering section that is distant from the second power soldering section, and the second differential spring section is located at one side of the first differential spring section that is distant from the first grounding spring section;
a third signal transmission conductor, wherein the third signal transmission conductor has two ends that are extended to respectively form a third signal soldering section and a third signal spring section, and the third signal soldering section is located at one side of the second differential soldering section that is distant from the first differential soldering section, and the third signal spring section is located at one side of the second power spring section that is distant from the command reset spring section;
a second grounding transmission conductor, wherein the second grounding transmission conductor has two ends that are extended to respectively form a second grounding soldering section and a second grounding spring section, and the second grounding soldering section is located at one side of the third signal soldering section that is distant from the second differential soldering section, and the second grounding spring section is located at one side of the second differential spring section that is distant from the first differential spring section;
a third grounding transmission conductor, wherein the third grounding transmission conductor has two ends that are extended to respectively form a third grounding soldering section and a third grounding spring section, and the third grounding soldering section is located at one side of the second grounding soldering section that is distant from the third signal soldering section, and the third grounding spring section is located at one side of the third signal spring section that is distant from the second power spring section;
a third differential transmission conductor, wherein the third differential transmission conductor has two ends that are extended to respectively form a third differential soldering section and a third differential spring section, and the third differential soldering section is located at one side of the third grounding soldering section that is distant from the second grounding soldering section, and the third differential spring section is located at one side of the second grounding spring section that is distant from the second differential spring section;
a fourth differential transmission conductor, wherein the fourth differential transmission conductor has two ends that are extended to respectively form a fourth differential soldering section and a fourth differential spring section, and the fourth differential soldering section is located at one side of the third differential soldering section that is distant from the third grounding soldering section, and the fourth differential spring section is located at one side of the third differential spring section that is distant from the second grounding spring section;
a fourth grounding transmission conductor, wherein the fourth grounding transmission conductor has two ends that are extended to respectively form a fourth grounding soldering section and a fourth grounding spring section, and the fourth grounding soldering section is located at one side of the fourth differential soldering section that is distant from the third differential soldering section, the fourth grounding spring section is located at one side of the third grounding spring section that is distant from the third signal spring section;
a fifth grounding transmission conductor, wherein the fifth grounding transmission conductor has two ends that are extended to respectively form a fifth grounding soldering section and a fifth grounding spring section, and the fifth grounding soldering section is located at one side of the fourth grounding soldering section that is distant from the fourth differential soldering section, and the fifth grounding spring section is located at one side of the fourth differential spring section that is distant from the third differential spring section;
a fifth differential transmission conductor, wherein the fifth differential transmission conductor has two ends that are extended to respectively form a fifth differential soldering section and a fifth differential spring section, and the fifth differential soldering section is located at one side of the fifth grounding soldering section that is distant from the fourth grounding soldering section, and the fifth differential spring section is located at one side of the fourth grounding spring section that is distant from the third grounding spring section;
a sixth differential transmission conductor, wherein the sixth differential transmission conductor has two ends that are extended to respectively form a sixth differential soldering section and a sixth differential spring section, and the sixth differential soldering section is located at one side of the fifth differential soldering section that is distant from the fifth grounding soldering section, and the sixth differential spring section is located at one side of the fifth differential spring section that is distant from the fourth grounding spring section; and
an outside grounding transmission conductor, wherein the outside grounding transmission conductor has two ends that respectively form a first outside grounding soldering section and a second outside grounding soldering section, and the outside grounding transmission conductor is formed with a retaining engagement spring section located at one side of the first signal spring section, and the first outside grounding soldering section is located at one side of the first signal soldering section that is distant from the first power soldering section, the second outside grounding soldering section is located at one side of the sixth differential soldering section that is distant from the fifth differential soldering section.

17. The card connector according to claim 16, wherein an insulative plastic body is arranged outside the transmission conductor assembly, and the insulative plastic body is provided with a first signal constraining section, an inspection signal constraining section located at one side of the first signal constraining section, a command reset constraining section located at one side of the inspection signal constraining section that is distant from the first signal constraining section, a second power constraining section located at one side of the command reset constraining section that is distant from the inspection signal constraining section, a first differential group constraining section located at one side of the second power constraining section that is distant from the command reset constraining section, a first power constraining section located at one side of the first signal constraining section, a second signal constraining section located at one side of the first power constraining section, a first grounding constraining section located at one side of the second signal constraining section that is distant from the first power constraining section, a second differential group constraining section located at one side of the first grounding constraining section that is distant from the second signal constraining section, a second grounding constraining section located at one side of the second differential group constraining section that is distant from the first grounding constraining section, a third differential group constraining section located at one side of the second grounding constraining section that is distant from the second differential group constraining section, a fifth grounding constraining section located at one side of the third differential group constraining section that is distant from the second grounding constraining section, and a retaining engagement spring constraining section located at one side of the first power constraining section.

18. The card connector according to claim 16, wherein the transmission conductor assembly is formed with a plurality of constraint fixing sections.

19. The card connector according to claim 16, wherein a shielding case is arranged outside the transmission conductor assembly, and the shielding case is provided with a plurality of collision protection sections.

20. The card connector according to claim 16, wherein the fifth differential transmission conductor, the sixth differential transmission conductor, the first differential transmission conductor, the second differential transmission conductor, the third differential transmission conductor, and the fourth differential transmission conductor have widths that are greater than widths of the first signal transmission conductor, the inspection signal transmission conductor, the command reset transmission conductor, the second power transmission conductor, the third signal transmission conductor, the third grounding transmission conductor, the fourth grounding transmission conductor, the first power transmission conductor, the second signal transmission conductor, the first grounding transmission conductor, the second grounding transmission conductor, and the fifth grounding transmission conductor.
